(19) United States
(12) Patent Application Publication
(10) Pub. No.: US 2023/0274379 A1
(43) Pub. Date: Aug. 31, 2023

(54) RENDERING OF ELECTRONIC VISUAL INDICATORS BASED ON PARSING OF STRUCTURED DATA RECORDS

(71) Applicant: Niche.com, Inc., Pittsburgh, PA (US)

(72) Inventors: Athena Meyers, Chevy Chase, MD (US); Mackenzie Marie Cavanaugh, Wexford State, PA (US); Kristina Quinn Gannotta, Glendora, NJ (US)

(21) Appl. No.: 18/114,646

(22) Filed: Feb. 27, 2023

Related U.S. Application Data
(60) Provisional application No. 63/314,037, filed on Feb. 25, 2022.

(51) Int. Cl. G06Q 50/20

(52) U.S. Cl. CPC G06Q 50/2053

(57) ABSTRACT

Methods, systems, apparatuses, and computer programs method for the rendering of electronic visual indicators based on parsing of structured data records are disclosed. The method can include receiving first data structures representing enrollment criteria from a school; generating an executable logic that identifies whether enrollment criteria are satisfied; reading second data structures representing profiles of school searchers registered on the web platform; parsing the fields of the second data structures to identify values of attributes; executing the executable logic against the identified values of the attributes; based on the executing, identifying a subset of the second data structures representing a first set of school searchers meeting enrollment criteria; identifying data structures in the subset representing a second set of school searchers; and causing rendering on a display device, of a graphical user interface with visual indicators of a conditional admission offer provided to the second set of school searchers.

### CROSS-REFERENCE TO RELATED APPLICATIONS

This application claims priority to U.S. Provisional Pat. Application Serial No. 63/314,037, filed on Feb. 25, 2022, which is hereby incorporated by reference in its entirety.

### BACKGROUND

With college enrollments continuing to decline, most schools are struggling to fill their classes and achieve their enrollment goals. Meanwhile, the college application process is inefficient for school searchers, who face rigid deadlines, time-consuming applications and essays, and exorbitant costs to secure admission at a college of their choice. Additionally, there is a lack of transparency in the application process, leading to the uncertainty of school searchers about whether they’ll get admitted and whether they can afford it.

### SUMMARY

according to one innovative aspect of the present disclosure, a method for the rendering of electronic visual indicators based on parsing of structured data records is disclosed. In one aspect, the method can include receiving, by a data processing system associated with a web platform, one or more first data structures representing one or more enrollment criteria from a school; generating, by the data processing system and based on the one or more first data structures, an executable logic that identifies whether the one or more enrollment criteria are satisfied; reading, by the data processing system and from a hardware storage device, second data structures representing school searchers registered on the web platform, wherein the second data structures are structured with fields, wherein the fields represent attributes of the school searchers and the fields store values of the attributes; parsing, by a parser of the data processing system, the fields of the second data structures to identify the values of the attributes; executing, by the data processing system, the executable logic against the identified values of the attributes; based on the executing, identifying, by the data processing system, a subset of the second data structures representing a first set of school searchers meeting the one or more enrollment criteria of the school from the school searchers registered on the web platform; identifying, by the data processing system and among the subset of the second data structures, one or more data structures in the subset representing a second set of school searchers, wherein each of the identified one or more data structures includes a first field representing a qualified inquiry of the school and a second field storing a value indicating the qualified inquiry; and causing rendering, by the data processing system, on a display device, of a graphical user interface with one or more visual indicators of a conditional admission offer provided to the second set of school searchers, wherein the second set of school searchers are conditionally admitted school searchers.

Other aspects include apparatuses, systems, and computer programs for performing the actions of the aforementioned method.

The innovative method can include other optional features. For example, in some implementations, the method further includes sending a conditional scholarship offer to the one or more qualified inquiries from the second set of school searchers.

In some implementations, the method further includes incorporating the information related to the conditional admission offer and the conditional scholarship offer into a customer relationship management (CRM) system of the school.

In some implementations, the method further includes sending information related to the conditional admission offer and the conditional scholarship offer to the school through a secure file transfer protocol (SFTP).

In some implementations, the method further includes encrypting the information related to the conditional admission offer and the conditional scholarship offer into encrypted data; and sending the encrypted data to an SFTP server of the school.

In some implementations, the method further includes sending one or more notifications reminding the one or more conditionally admitted school searchers of one or more actions to be taken associated with enrollment in the school.

In some implementations, the method further includes tracking activities of the school searchers performed on the web platform, using a tracking pixel.

In some implementations, identifying the second set of school searchers expressing the interest in the school further comprises identifying the second set of school searchers that added the school to a school list or favorites on the web platform.

In some implementations, the method further includes receiving a school report including enrollment data of the school; identifying school searchers enrolled in the school based on the school report; and excluding the school searchers enrolled in the school from receiving a new conditional admission offer from other schools.

According to another innovative aspect of the present disclosure, a system for the rendering of electronic visual indicators based on parsing of structured data records is disclosed. In one aspect, the system can include at least one processor associated with a web platform; and a memory storing instructions thereon that, when executed by the at least one processor, cause the at least one processor to perform operations, comprising: receiving one or more first data structures representing one or more enrollment criteria from a school; generating, based on the one or more first data structures, an executable logic that identifies whether the one or more enrollment criteria are satisfied; reading, from a hardware storage device, second data structures representing profiles of school searchers registered on the web platform, wherein the second data structures are structured with fields, wherein the fields represent attributes of the school searchers and the fields store values of the attributes; parsing the fields of the second data structures to identify the values of the attributes; executing the executable logic against the identified values of the attributes; based on the executing, identifying, from school searchers registered on the web platform, a subset of the second data structures representing a set of school searchers meeting the one or more enrollment criteria of the school; causing rendering, on a display device, of a graphical user interface with one or more visual indicators of a conditional admission offer provided to the set of school searchers; outputting one or more visual indicators of conditionally admitting one or more school searchers, among the set of school searchers, to the school based on an interest expressed from the one or more school searchers.

The innovative system can include other optional features. For example, in some implementations, the system includes operations further comprising sending a conditional scholarship offer to a subset of prospects from the set of school searchers.

In some implementations, the system includes operations further comprising sending information related to the conditional admission offer and the conditional scholarship offer to the school through a secure file transfer protocol (SFTP).

In some implementations, the system includes operations further comprising incorporating the information related to the conditional admission offer and the conditional scholarship offer into a customer relationship management (CRM) system of the school.

In some implementations, the system includes operations further comprising encrypting the information related to the conditional admission offer and the conditional scholarship offer into encrypted data; and sending the encrypted data to an SFTP server of the school.

In some implementations, the system includes operations further comprising sending one or more notifications reminding one or more conditionally admitted prospects of one or more actions to be taken associated with enrollment in the school.

In some implementations, the system includes operations further comprising tracking activities of the school searchers performed on the web platform, using a tracking pixel.

In some implementations, the system includes operations further comprising outputting one or more visual indicators of canceling the conditional admission offer of one or more second prospects based on no interest expressed from the one or more second prospects among the set of school searchers.

According to another innovative aspect of the present disclosure, a computer-readable storage medium for the rendering of electronic visual indicators based on parsing of structured data records is disclosed. In one aspect, the non-transitory, computer-readable storage medium having instructions stored thereon, that when executed by at least one processor associated with a web platform, cause the at least one processor to perform operations, including: receiving one or more first data structures representing one or more enrollment criteria from a school; generating, based on the one or more first data structures, an executable logic that identifies whether the one or more enrollment criteria are satisfied; reading, from a hardware storage device, second data structures representing school searchers registered on the web platform, wherein the second data structures are structured with fields, wherein the fields represent attributes of the school searchers and the fields store values of the attributes; parsing the fields of the second data structures to identify the values of the attributes; executing the executable logic against the identified values of the attributes; based on the executing, identifying a subset of the second data structures representing a first set of school searchers meeting the one or more enrollment criteria of the school from the school searchers registered on the web platform; identifying, among the subset of the second data structures, one or more data structures in the subset representing a second set of school searchers, wherein each of the identified one or more data structures includes a first field representing a qualified inquiry of the school and a second field storing a value indicating the qualified inquiry; and causing rendering on a display device, of a graphical user interface with one or more visual indicators of a conditional admission offer provided to the second set of school searchers, wherein the second set of school searchers are conditionally admitted school searchers.

The innovative computer-readable storage medium can include other optional features. For example, in some implementations, the computer-readable storage medium includes operations further comprising receiving a school report including enrollment data of the school; identifying school searchers enrolled in the school based on the school report; and excluding the school searchers enrolled in the school from receiving a new conditional admission offer from other schools.

### BRIEF DESCRIPTION OF THE DRAWINGS

FIG. 1 is an example auto-admitting system according to some implementations.

FIG. 2 is an example school profile, in accordance with one aspect of the present disclosure.

FIG. 3 is a flowchart of an example process for auto-admitting school searchers, in accordance with one aspect of the present disclosure.

FIG. 4 is an example conditional admission offer for a qualified inquiry, in accordance with one aspect of the present disclosure.

FIG. 5 is another example conditional admission offer for a qualified inquiry, in accordance with one aspect of the present disclosure.

FIG. 6 is an example Secure File Transfer Protocol (SFTP) transfer system, in accordance with one aspect of the present disclosure.

FIG. 7 is a flowchart of another example process for auto-admitting school searchers, in accordance with one aspect of the present disclosure.

FIG. 8 is an example conditional admission offer for a prospect, in accordance with one aspect of the present disclosure.

FIGS. 9A-9B illustrate an example report provided from a school, in accordance with one aspect of the present disclosure.

FIG. 10 is a flowchart of another example process for auto-admitting school searchers, in accordance with one aspect of the present disclosure.

FIG. 11 is an example computing device for an auto-admitting system, in accordance with one aspect of the present disclosure.

Like reference symbols in the various drawings indicate like elements.

### DETAILED DESCRIPTION

This disclosure describes methods and systems for auto-admitting school searchers to academic institutions (e.g., colleges, graduate schools, high schools, middle schools, elementary schools, kindergartens, etc.) based on user profiles (e.g., profiles of school searchers who are users of a third entity, e.g., Niche.com, Inc.). The methods and systems enable schools (e.g., colleges, graduate schools, high schools, middle schools, elementary schools, kindergartens, etc.) to leverage the school searchers’ profiles on the third entity (e.g., Niche.com, Inc.) to admit qualifying school searchers and offer scholarships even if the school searchers have not applied for the schools. The methods and systems enable schools to bring opportunities directly to school searchers. The school searchers, in turn, learn of higher education opportunities that they were not aware of. The methods and systems provide greater transparency of admission and scholarship, and simplify a historically cumbersome application process.

In some implementations, the terms “Students,” “student,” “school searchers,” and “school searcher” may be used interchangeably in the description. The one skilled in the art can understand that any school searchers, e.g., students, students’ parents, working adults, etc., can apply to these implementations.

In some implementations, the third entity is a platform that works between college searchers (e.g., prospective students or their parents, working adults) and colleges. The platform has profiles of college searchers, including demographics, academic information (such as transcripts), school searcher behavioral data, e.g., actions that the college searchers take on the platform (such as viewing school profiles, adding one or more schools to a school list or favorites, reading reviews of schools, etc.), schools they are interested in attending, etc. The platform further has information from partner schools including their enrollment criteria.

In some implementations, the profiles of college searchers stored on the platform can serve as an application for schools that partner with the platform. Schools can use the profiles to offer conditional admission and scholarships, without submitting a formal application by the college searchers or college candidates. Students (e.g., college searchers or college candidates) who are conditionally admitted are subject to verification of information in the profiles. The platform can identify school searchers who would be a fit for partner schools and offer conditional admission of partner schools to the identified school searchers, based on profiles of school searchers. For example, the platform can identify ‘look alike’ school searchers who enrolled in a particular school and ‘look alike’ schools that a particular school searcher is interested in (e.g., the schools that the particular school searcher added to a school list or ‘favorites’ are schools that the particular school searcher expressed interest in).

In some implementations, school searchers input their profiles on a website of the platform or a mobile application of the platform. The profiles include demographic information, academic information, and information about their interests (such as majors and schools that the school searchers are interested in). Schools also have profiles on the website of the platform or the mobile application of the platform, including an introduction of the schools and key statistics about the school (such as location, number of enrolled school searchers, etc.).

In some implementations, the platform can provide relevant information to school searchers in real time. For example, if a school searcher adds a school to his/her school list, the platform can share relevant information (e.g., whether the school searcher is conditionally admitted, campus tour information, school counselor information, scholarship information, etc.) with the school searcher immediately. For example, if a school provides the school’s admission and scholarship criteria to the platform, the platform can share the relevant information with school searchers who meet the criteria immediately.

In some implementations, the platform, as a two-sided platform, can provide conditional college admissions directly to the school searchers based on school searchers’ profiles on the platform. Conditional admission from a college is provided to school searchers that haven’t applied for this college. The conditional admission can be converted to a full admission upon verification of school searchers’ information (e.g., GPA, demographic information, etc.) in the profiles on the platform. The conditional admission may be accompanied by monetary incentives, e.g., guaranteed merit scholarship for school searchers with a GPA equal to or higher than a predetermined GPA threshold.

In some implementations, a particular school provides the platform with enrollment criteria (such as GPA) for school searchers to qualify for admissions and scholarships. The platform searches all the school searcher profiles on the platform, and identifies a set of school searcher profiles from all the school searcher profiles that match the enrollment criteria of a particular school. The platform notifies the set of school searchers of conditional admission and scholarship (if applicable) on behalf of the particular school. For example, the platform can notify the set of school searchers by an email, a text message, a push message from the mobile application, a phone call, etc. In some implementations, the particular school directly contacts conditionally admitted school searchers for later stages (full admission, deposit payment, enrollment). In some implementations, the platform can continue to follow up with the set of school searchers from conditional admission to enrollment by sending reminders at different stages (e.g., full admission, deposit payment, enrollment), information relevant to enrollment (e.g., school counselor’s contact information, enrollment due date, information of student clubs) of the particular school, or/and invitations to an on-campus event.

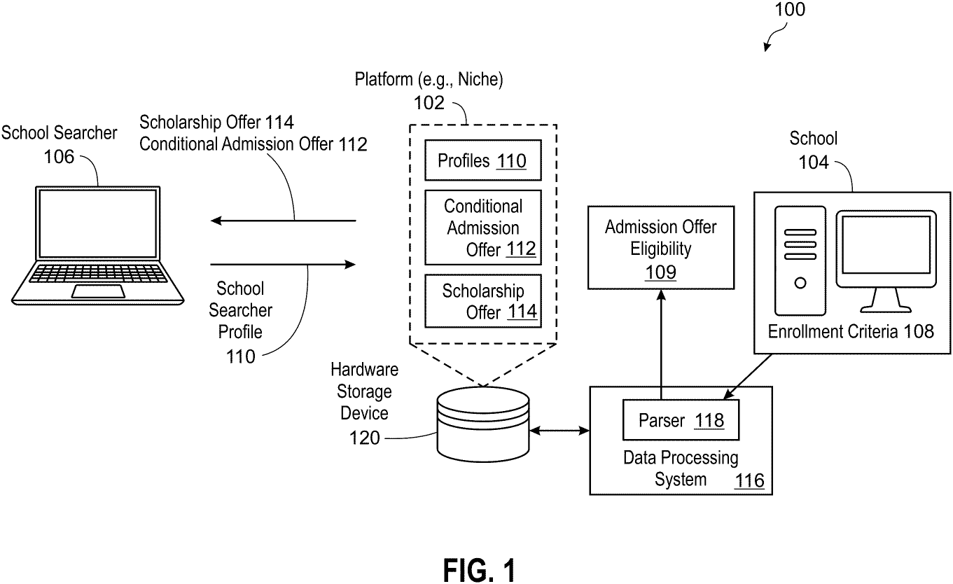

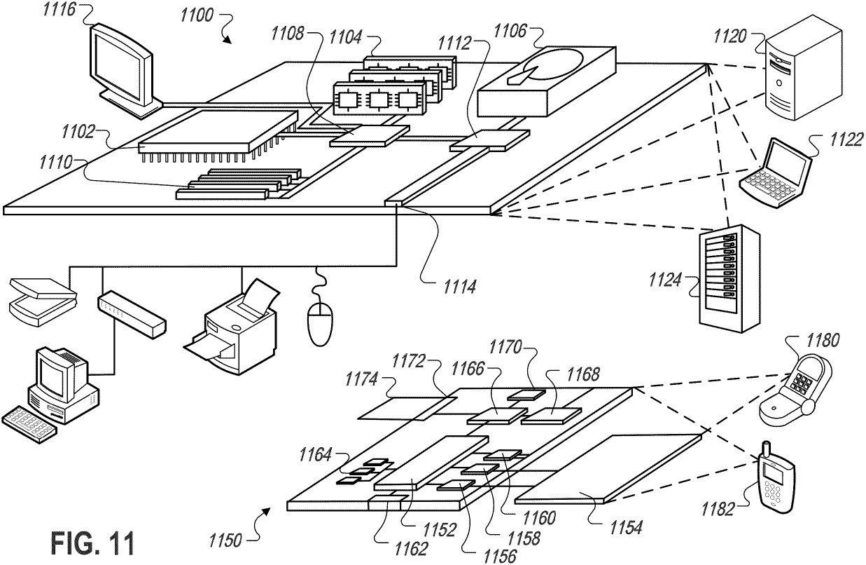

FIG. 1 is an example auto-admitting system 100 according to some implementations. The auto-admitting system 100 includes a web platform 102 (e.g., a website of Niche.com, Inc.) for providing conditional admission and an optional scholarship (if applicable) of an example school 104 to qualified school searchers 106. The auto-admitting system 100 can be implemented on a computing device, e.g., the computing device 1100 of FIG. 11.

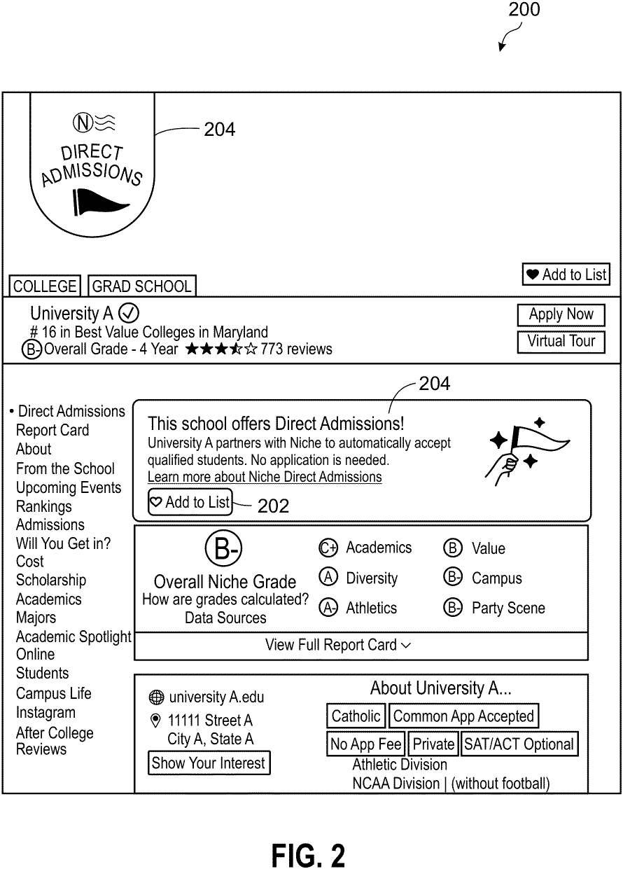

The web platform 102 is a two-sided platform working as a “bridge” between the school 104 and the school searchers 106. The web platform 102 has a large number of school searcher profiles, e.g., millions of school searcher profiles and a large number of school profiles, e.g., thousands of school profiles. FIG. 2 is an example school profile 200, in accordance with one aspect of the present disclosure. If a school searcher clicks “Add to List” 202 in the school profile 200, the school searcher expresses an interest in the school. In some implementations, the school searcher may recognize one or more visual indicators 204 indicating “Direct Admissions” in the school profile 200 and understands that the school participates in “Direct Admissions” which can conditionally admit school searchers based on school searcher profiles of the web platform 102.

The school 104 provides one or more enrollment criteria 108 (e.g., GPA higher than 3.2, high school absence rate lower than 0.1%, volunteer service days more than three months, etc.). The web platform 102 searches all the school searcher profiles 110, and identifies a set of school searcher profiles from all the school searcher profiles 110 that match the enrollment criteria 108 of the school 104. The web platform 102 sends a conditional admission offer 112 (e.g., for school searchers having GPA higher than 3.2) and an optional scholarship offer 114 (e.g., for school searchers having GPA higher than 3.3) to the identified set of school searchers 106.

In some implementations, the web platform 102 is implemented on a data processing system 116 or a computing device (e.g., the computing device 1100 of FIG. 11) or a processor (processor 1102, 1152 of FIG. 11). The data processing system 116 includes a parser 118 for receiving and parsing a data structure representing the enrollment criteria 108. The parser 118 parses fields of the data structure representing the enrollment criteria 108 to determine admission offer eligibility 109. The auto-admitting system 100 further includes a hardware storage device or a memory 120 for storing structured data records associated with the web platform 102. For example, the hardware storage device 120 includes a first data structure representing school searcher profiles 110, a second data structure representing conditional admission offers 112, and a third data structure representing optional scholarship offers 114. If the parser 118 determines that the offer is eligible for a school searcher 106, the platform 102 can send the conditional admission offers 112 and the optional scholarship offers 114 to the school searcher 106, and the second data structure representing conditional admission offers 112 and the third data structure representing scholarship offers 114 are stored in the hardware storage device 120.

In some implementations, the hardware storage device 120 (e.g., the memory 1104, 1164 of FIG. 11) and the data processing system 116 (processor 1102, 1152 of FIG. 11) can be integrated. In some implementations, the hardware storage device 120 and the data processing system 116 are separate. The hardware storage device 120 can be a local database, a remote database, a cloud server, or the like.

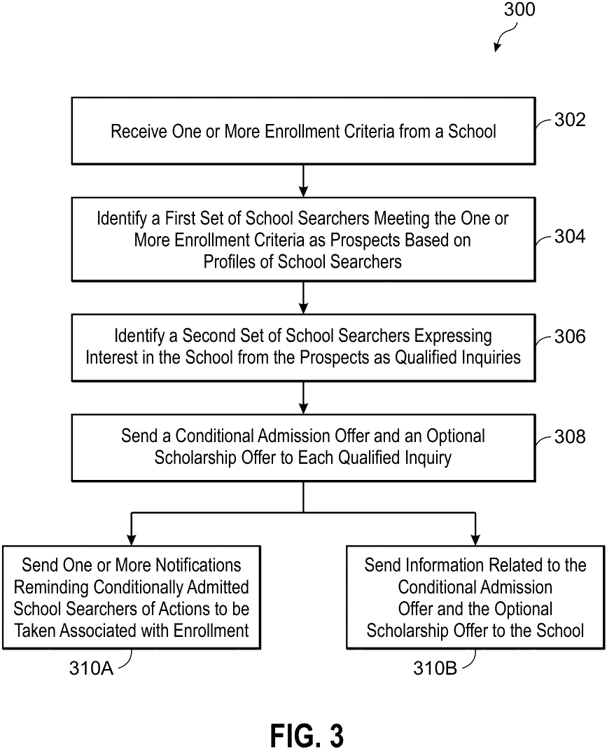

FIG. 3 is a flowchart of an example process 300 for auto-admitting school searchers, in accordance with one aspect of the present disclosure. The process 300 will be described as being performed by a platform (e.g., the web platform 102) implemented on a computing device, e.g., the computing device 1100 of FIG. 11, or a processor, e.g., the processor 1102, 1152 of FIG. 11.

The platform (e.g., the web platform 102) can begin execution of the process 300 by receiving one or more enrollment criteria of a school 302. In some implementations, the enrollment criteria include a GPA criterion. For example, the school only admits school searchers having GPAs higher than a predetermined GPA threshold, e.g., 3.2.

The platform can continue execution of the process 300 by identifying a first set of school searchers meeting the one or more enrollment criteria of the school based on profiles of the school searchers 304. The first set of school searchers meeting the enrollment criteria are referred to as prospects of the school. The platform compares the profile of each school searcher registered on the platform with the enrollment criteria, and identifies the first set of school searchers meeting the criteria.

The platform can continue execution of the process 300 by identifying a second set of school searchers expressing interest in the school from the prospects 306. The second set of school searchers expressing interest in the school are referred to as qualified inquiries of the school. In some implementations, if a prospect has added the school to his/her list of schools of interest or his/her favorites on the platform, this prospect becomes a qualified inquiry of the school. The platform can identify all the qualified inquiries that have added the school to their lists of schools of interest or their favorites.

In some implementations, the website of the platform includes at least one tracking pixel for tracking activities or actions of users (e.g., school searchers) on the platform. A tracking pixel, also referred to as a 1×1 pixel or a pixel tag, is a graphic having a dimension of a 1x1 pixel that is loaded when a user (e.g., a school searcher) visits a website. A uniform resource locator (URL) of the tracking pixel is a memory location on a computing device (e.g., the computing device 1100 of FIG. 11) implementing the platform. When a user visits the website, the tracking pixel is loaded from the computing device. The tracking pixel is implemented on the website using a snippet of code, which is incorporated into the website’s hypertext markup language (HTML) code. The snippet of code associated with the tracking pixel includes a link to the URL of the tracking pixel. When a user visits the website, the HTML code including the snippet of code is processed by the user’s browser. The browser follows the link to the URL of the tracking pixel and opens the graphic. The tracking pixel acquires information about the website’s user and actions that the user takes on the website. For example, the tracking pixel can track which school profiles a user browses and which schools are added to the user’s school list or favorites. If the user adds a school to his/her school list or favorites, the user is a qualified inquiry of the school.

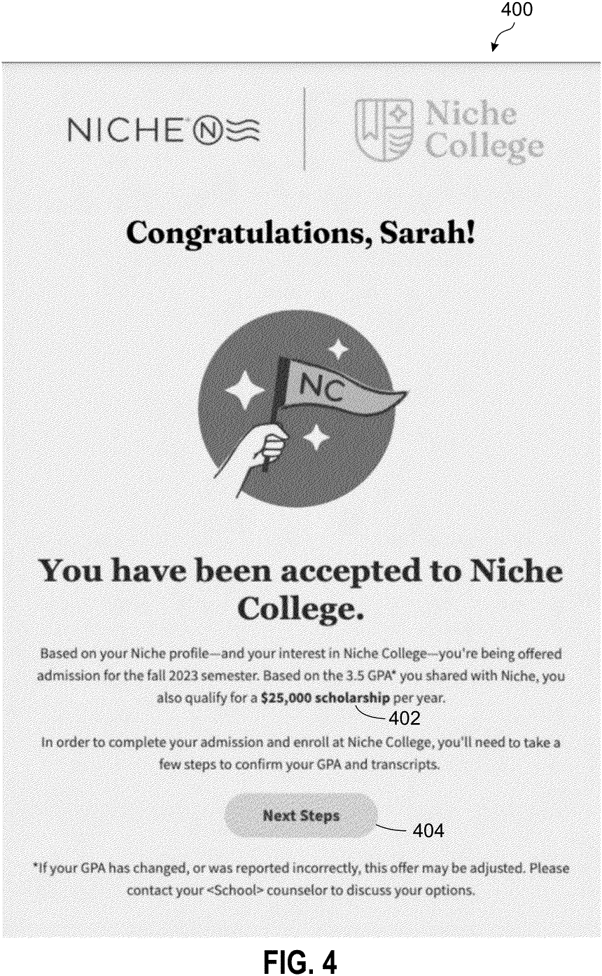

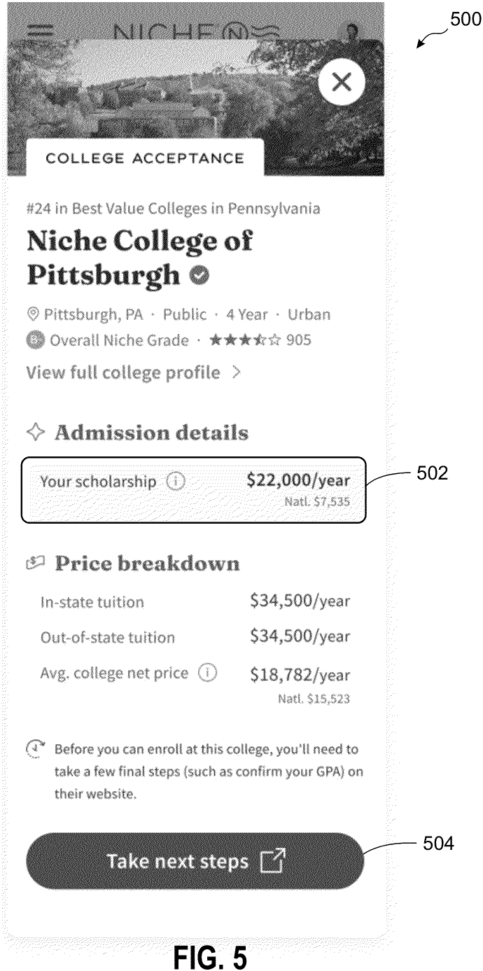

The platform can continue execution of the process 300 by sending a conditional admission offer and an optional scholarship offer to each qualified inquiry 308. The platform sends a conditional admission offer and a scholarship offer (optionally depending on GPA) to each qualified inquiry. Upon receipt of the conditional admission offer and the scholarship offer, qualified inquiries become conditionally admitted school searchers. The conditional admission offer is conditioned on verification of profile information of each qualified inquiry. FIG. 4 is an example conditional admission offer 400 for a qualified inquiry, in accordance with one aspect of the present disclosure. The example conditional admission offer 400 is accompanied by a scholarship offer 402. FIG. 5 is another example conditional admission offer 500 for a qualified inquiry, in accordance with one aspect of the present disclosure. The example conditional admission offer 500 is also accompanied by a scholarship offer 502.

In some implementations, the conditional admission offer and an optional scholarship offer can be sent to each qualified inquiry through an email, a text message, a message on the platform or a mobile application of the platform, a phone call, or any other communication techniques. In some implementations, a school searcher dashboard of the qualified inquiry on the platform is updated to indicate the received conditional admission offer and the optional scholarship offer from the school. In some implementations, the notification of the conditional admission offer also includes at least one link associated with the conditional admission offer. For example, the link “Next Steps” 404 of FIG. 4 or the link “Take next steps” 504 of FIG. 5 is associated with actions to be taken toward enrollment. In some implementations, when clicking the link 404 or 504, the conditionally admitted school searcher connects to the website of the school for the next actions, e.g., uploading a transcript and a proof of demographic information.

In some implementations, the platform can continue execution of the process 300 by sending one or more notifications reminding conditionally admitted school searchers of actions to be taken associated with enrollment 310A. The platform continuously follows up with the conditionally admitted school searchers toward enrollment. For example, the platform can send one or more notifications reminding conditionally admitted school searchers to upload a transcript, schedule a campus visit, contact an admission counselor of the school, fill in forms required by the school, pay a deposit, etc. The platform can send the one or more notifications through an email, a text message, a message on a website of the platform or a mobile application of the platform, a phone call, or any other communication techniques. The one or more notifications can be sent to the conditionally admitted school searchers within a predetermined time period. In some implementations, the school, instead of the platform, sends the one or more notifications to the conditionally admitted school searchers directly (e.g., via emails or text messages).

In some implementations, the platform can continue execution of the process 300 by sending information related to the conditional admission offer and the optional scholarship offer to the school 310B. The school is notified of the information related to the conditional admission offer and the optional scholarship offer, e.g., school searcher platform identification (ID), the amount of the scholarship, etc.

In some implementations, the platform can send information related to the conditional admission offer and the optional scholarship offer to the school through a secure file transfer protocol (SFTP). SFTP is a network protocol for securely accessing, transferring, and managing files and sensitive data. As an extension of Secure Shell (SSH), SFTP enables access, transfer, and management of files over a network.

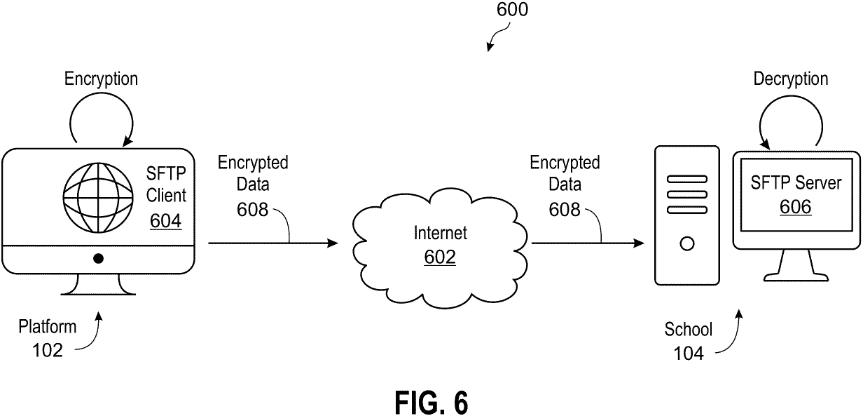

FIG. 6 is an example Secure File Transfer Protocol (SFTP) transfer system 600, in accordance with one aspect of the present disclosure. The SFTP data transfer system 600 for transferring data from the platform 102 to the school 104 through the internet 602 includes an SFTP client 604 and an SFTP server 606. The SFTP client 604 is an application operating on a computing device (e.g., the computing device 1100 of FIG. 11) for implementing the platform 102. The SFTP server 606 is an application operating on a computing device (e.g., the computing device 1100 of FIG. 11) of the school 104. The SFTP client 604 connects to the SFTP server 606 and stores files or data (e.g., information related to the conditional admission offer and the conditional scholarship offer) on the SFTP server 606.

The original files or data from the platform 102 are in a plain text format. The original files or data are encrypted by the SFTP client 604 into encrypted data in a ciphertext format. The encrypted data 608 is transferred to the SFTP server 606 through the internet 602. The encrypted data 608 is decrypted by the SFTP server 606 into the original files or data in a plain text format. The SFTP data transfer system 600 securely moves the original files or data to the SFTP server 606, keeping files unreadable during the data transfer.

In some implementations, the information related to the conditional admission offer and the conditional scholarship offer received by the school 104 is incorporated into a customer relationship management (CRM) system (e.g., Slate) of the school. For example, the school can add fields (e.g., school searcher ID of the platform; Conditional Admission Offer, Conditional Admission Date, Conditional Scholarship) into a Slate instance, and the information related to the conditional admission offer and the conditional scholarship offer is incorporated into the Slate instance using the fields.

In some implementations, the information related to the conditional admission offer and the optional scholarship offer can be transferred to the school by Application Programming Interface (API) or an email having one or more secure links, or any other data transferring techniques.

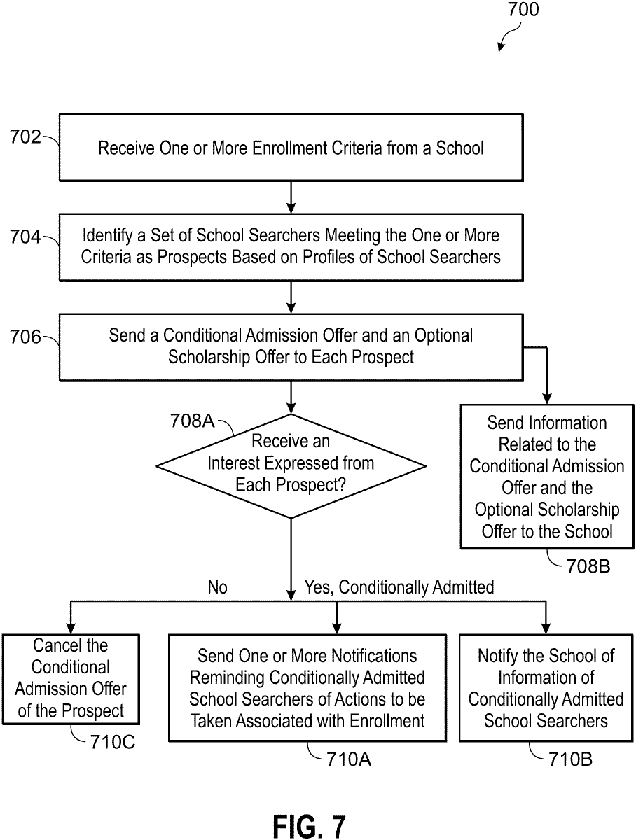

FIG. 7 is a flowchart of another example process for auto-admitting school searchers, in accordance with one aspect of the present disclosure. The process 700 will be described as being performed by a platform (e.g., the web platform 102) implemented on a computing device, e.g., the computing device 1100 of FIG. 11, or a processor, e.g., the processor 1102, 1152 of FIG. 11.

The platform (e.g., the web platform 102) can begin execution of the process 700 by receiving one or more enrollment criteria of a school 702 (similar to 302 of FIG. 3). In some implementations, the enrollment criteria include a GPA criterion. For example, the school only admits school searchers having GPA higher than a predetermined GPA threshold, e.g., 3.2.

The platform can continue execution of the process 700 by identifying a set of school searchers meeting the one or more enrollment criteria of the school based on profiles of the school searchers on the platform 704 (similar to 304 of FIG. 3). These school searchers who meet the enrollment criteria and have consented to have their information shared with any schools are referred to as prospects of the school. The platform compares the profile of each school searcher registered on the platform with the enrollment criteria, and identifies the set of school searchers meeting the criteria.

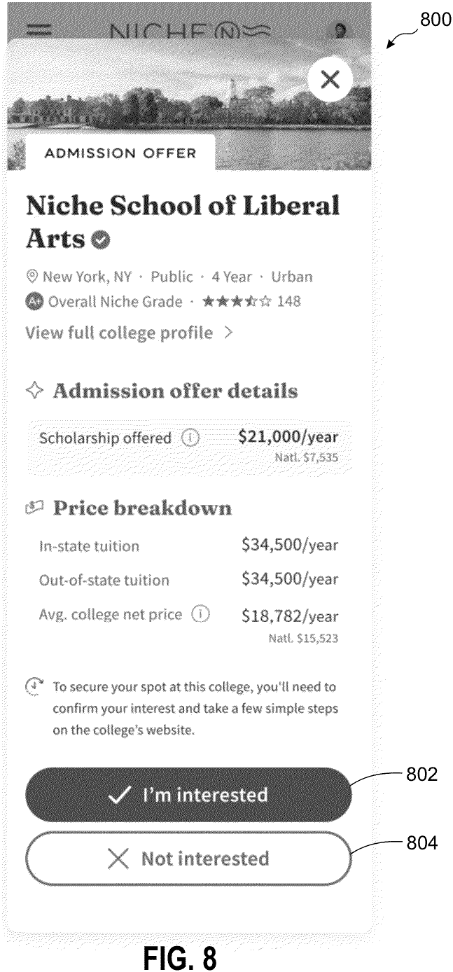

The platform can continue execution of the process 700 by sending a conditional admission offer and an optional scholarship offer to each prospect 706. The platform sends a conditional admission offer and a scholarship offer (optionally depending on GPA) to each prospect. FIG. 8 is an example conditional admission offer 800 for a prospect, in accordance with one aspect of the present disclosure.

The platform can continue execution of the process 700 by checking whether each prospect expresses an interest in the school 708A. For example, as shown in FIG. 8, if a prospect clicks “I’m interested” 802 or adds the school to his/her school list or favorites, the prospect becomes a conditionally admitted school searcher. The conditional admission offer is conditioned on the verification of profile information of each conditionally admitted school searcher.

In some implementations, the platform can continue execution of the process 700 by sending information related to the conditional admission offer and the optional scholarship offer to the school 708B. The school is notified of the information related to the conditional admission offer and the optional scholarship offer, e.g., school searcher platform identification (ID), the amount of the scholarship, etc.

In some implementations, if the prospect is conditionally admitted, the platform can continue execution of the process 700 by sending one or more notifications reminding conditionally admitted school searchers of actions to be taken associated with enrollment 710A. The platform continuously follows up with the conditionally admitted school searchers toward enrollment. For example, the platform can send one or more notifications reminding conditionally admitted school searchers to upload a transcript, schedule a campus visit, contact an admission counselor of the school, fill in forms required by the school, pay a deposit, etc. In some implementations, the school, instead of the platform, sends the one or more notifications to the conditionally admitted school searchers directly (e.g., via emails or text messages).

In some implementations, if the prospect is conditionally admitted, the platform can continue execution of the process 700 by notifying the school of information of conditionally admitted school searchers 710B. The school is notified of school searchers that were conditionally admitted by the platform.

In some implementations, as shown in FIG. 8, if the prospect clicks “Not interested” 804 or fails to click either 802 or 804, in some implementations, the platform can continue execution of the process 700 by canceling the conditional admission offer of the prospect 710C.

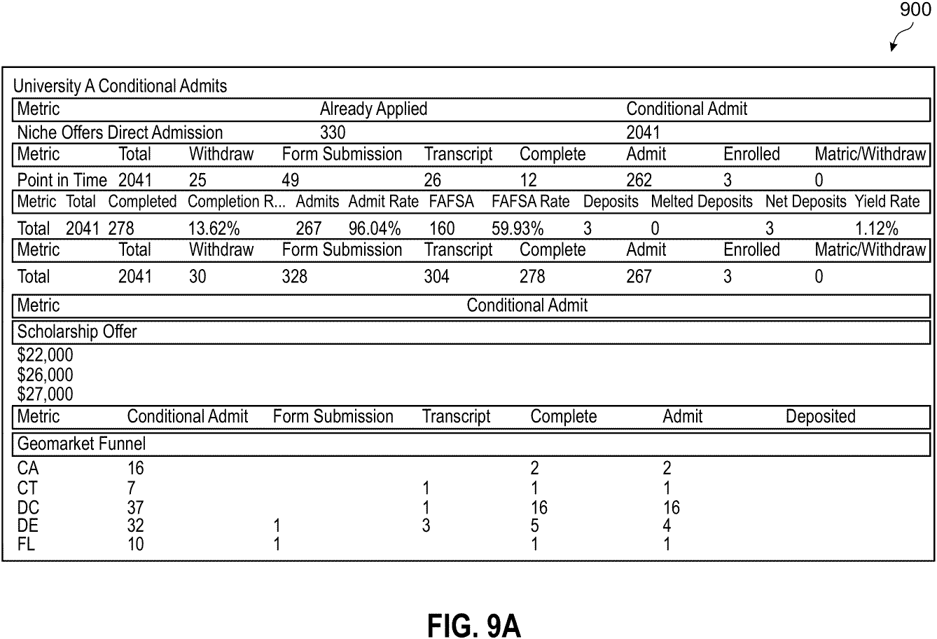

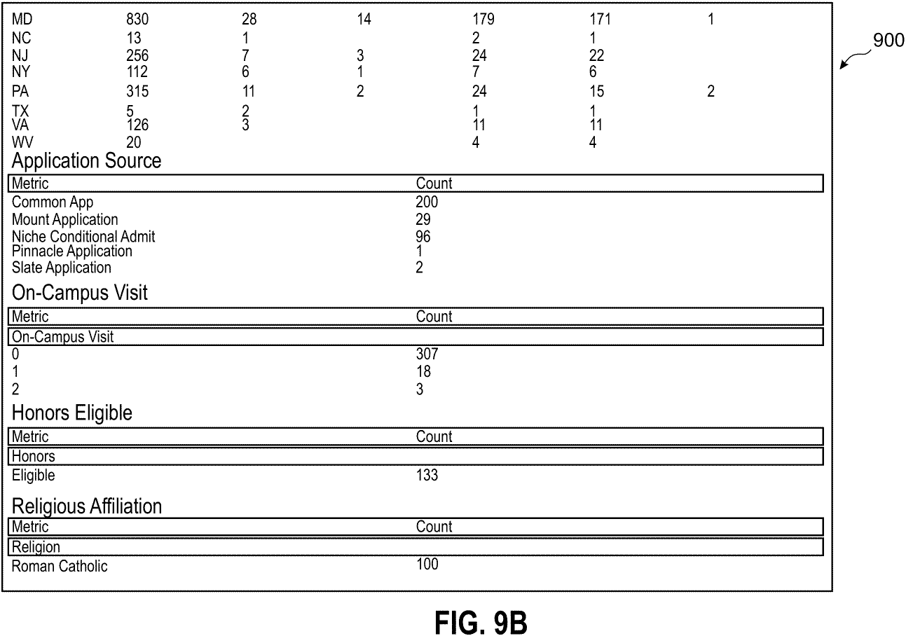

In some implementations, the platform can receive school searcher enrollment data from schools for further analysis. In some implementations, the school can transfer admission data (e.g., fully admitted school searcher) to the platform for further analysis. For example, the platform can create a school searcher dashboard for each school searcher based on the admission data transferred from the school. FIGS. 9A-9B illustrate an example report provided by a school, in accordance with one aspect of the present disclosure. The report provides detailed data (e.g., the number of school searchers) at different stages from conditional admission to enrollment. In some implementations, the platform identifies school searchers who are enrolled or have paid a deposit to a particular school based on the report, and these school searchers would be excluded from conditional admission offers from other schools (the platform stops sending conditional admission offers to these school searchers.

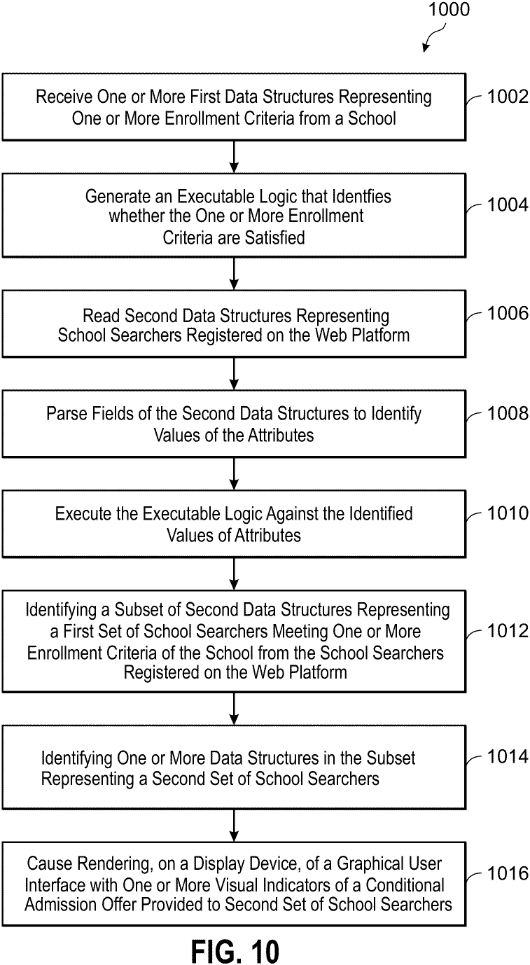

FIG. 10 is a flowchart of another example process 1000 for auto-admitting school searchers, in accordance with one aspect of the present disclosure. The process 1000 will be described as being performed by a platform (e.g., the web platform 102) implemented on a computing device, e.g., the computing device 1100 of FIG. 11, or a processor, e.g., the processor 1102, 1152 of FIG. 11.

The platform (e.g., the web platform 102) can begin execution of the process 1000 by receiving one or more first data structures representing one or more enrollment criteria from a school 1002.

The platform can continue execution of the process 1000 by generating an executable logic that can identify whether the one or more enrollment criteria (e.g., enrollment criteria 108 of FIG. 1) are satisfied 1004. The executable logic can be instructions or codes for execution within a computing device (e.g., computing device 1100 of FIG. 11) or a data processing system (e.g., data processing system 116 of FIG. 1). The data processing system can generate an executable logic (e.g., instructions or codes) upon receipt of the first data structures representing one or more enrollment criteria. The executable logic is used to identify whether the one or more enrollment criteria are satisfied.

The platform can continue execution of the process 1000 by reading second data structures representing profiles of school searchers (e.g., profiles 110 of FIG. 1) registered on the web platform 1006. The second data structures can be read from a hardware storage device (e.g., hardware storage device 120 of FIG. 1).

The platform can continue execution of the process 1000 by parsing fields of the second data structures to identify values of the attributes 1008. The parser (e.g., parser 118 of FIG. 1) of a data processing system (e.g., the data processing system 116 of FIG. 1) parses fields of second data structures representing profiles of school searchers to identify or obtain values of the attributes in the second data structure. The second data structure includes at least one field representing a school searcher’s attribute (e.g., Name, Age, Address, GPA; high school; family income, etc.) and at least one field storing a value of the attribute (e.g., “Mike”; “18”; “Street A, City A”; 3. 6; high school A; $50,000 per year, etc.).

The platform can continue execution of the process 1000 by executing the executable logic against the identified values of attributes 1010. The platform executes the executable logic generated at 1004 against the values of attributes identified at 1008.

The platform can continue execution of the process 1000 by identifying a subset of the second data structures representing a first set of school searchers meeting the one or more enrollment criteria (e.g., enrollment criteria 108 of FIG. 1) of the school from the school searchers registered on the web platform 1012. A first set of school searchers meeting enrollment criteria are identified based on execution of the executable logic at 1010. The first set of school searchers are prospects of the school.

The platform can continue execution of the process 1000 by one or more data structures in the subset representing a second set of school searchers 1014. Each of the identified one or more data structures includes a first field representing a qualified inquiry of the school and a second field storing a value indicating the qualified inquiry. A second set of school searchers expressing an interest in the school are identified. The second set of school searchers are qualified inquiries of the school.

The platform can continue execution of the process 1000 by causing rendering, on a display device, of a graphical user interface with one or more visual indicators of a conditional admission offer provided to second set of school searchers 1016. A conditional admission offer is provided to the second set of school searchers and shown on a display (e.g., display 1116 of FIG. 11) as one or more visual indicators (e.g., a message, an icon, or an animation or a combination thereof).

FIG. 11 is an example computing device 1100 for an auto-admitting system, in accordance with one aspect of the present disclosure. Computing device 1100 is intended to represent various forms of digital computers, such as laptops, desktops, workstations, personal digital assistants, servers, blade servers, mainframes, and other appropriate computers. Computing device 1150 is intended to represent various forms of mobile devices, such as personal digital assistants, cellular telephones, smartphones, and other similar computing devices. Additionally, computing device 1100 or 1150 can include Universal Serial Bus (USB) flash drives. The USB flash drives can store operating systems and other applications. The USB flash drives can include input/output components, such as a wireless transmitter or USB connector that can be inserted into a USB port of another computing device. The components shown here, their connections and relationships, and their functions, are meant to be exemplary only, and are not meant to limit implementations of the inventions described and/or claimed in this document.

Computing device 1100 includes a processor 1102, memory 1104, a storage device 1106, a high-speed interface 1108 connecting to memory 1104 and high-speed expansion ports 1110, and a low-speed interface 1112 connecting to low-speed bus 1114 and storage device 1106. Each of the components 1102, 1104, 1106, 1108, 1110, and 1112, are interconnected using various busses, and can be mounted on a common motherboard or in other manners as appropriate. The processor 1102 can process instructions for execution within the computing device 1100, including instructions stored in the memory 1104 or on the storage device 1106 to display graphical information for a GUI on an external input/output device, such as display 1116 coupled to high-speed interface 1108. In other implementations, multiple processors and/or multiple buses can be used, as appropriate, along with multiple memories and types of memory. Also, multiple computing devices 1100 can be connected, with each device providing portions of the necessary operations, e.g., as a server bank, a group of blade servers, or a multi-processor system.

The memory 1104 stores information within the computing device 1100. In one implementation, the memory 1104 is a volatile memory unit or units. In another implementation, the memory 1104 is a non-volatile memory unit or units. The memory 1104 can also be another form of a computer-readable medium, such as a magnetic or optical disk.

The storage device 1106 is capable of providing mass storage for the computing device 1100. In one implementation, the storage device 1106 can be or contain a computer-readable medium, such as a floppy disk device, a hard disk device, an optical disk device, a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The information carrier is a computer- or machine-readable medium, such as the memory 1104, the storage device 1106, or memory on processor 1102.

The high-speed controller 1108 manages bandwidth-intensive operations for the computing device 1100, while the low-speed controller 1112 manages lower bandwidth intensive operations. Such allocation of functions is exemplary only. In one implementation, the high-speed controller 1108 is coupled to memory 1104, display 1116, e.g., through a graphics processor or accelerator, and to high-speed expansion ports 1110, which can accept various expansion cards (not shown). In the implementation, low-speed controller 1112 is coupled to storage device 1106 and low-speed expansion port 1114. The low-speed expansion port, which can include various communication ports, e.g., USB, Bluetooth, Ethernet, wireless Ethernet, can be coupled to one or more input/output devices, such as a keyboard, a pointing device, microphone/speaker pair, a scanner, or a networking device such as a switch or router, e.g., through a network adapter. The computing device 1100 can be implemented in a number of different forms, as shown in the figure. For example, it can be implemented as a standard server 1120, or multiple times in a group of such servers. It can also be implemented as part of a rack server system 1124. In addition, it can be implemented in a personal computer such as a laptop computer 1122. Alternatively, components from computing device 1100 can be combined with other components in a mobile device (not shown), such as device 1150. Each of such devices can contain one or more of computing devices 1100, 1150, and an entire system can be made up of multiple computing devices 1100, 1150 communicating with each other.

The computing device 1100 can be implemented in a number of different forms, as shown in the figure. For example, it can be implemented as a standard server 1120, or multiple times in a group of such servers. It can also be implemented as part of a rack server system 1124. In addition, it can be implemented in a personal computer such as a laptop computer 1122. Alternatively, components from computing device 1100 can be combined with other components in a mobile device (not shown), such as device 1150. Each of such devices can contain one or more of computing device 1100, 1150, and an entire system can be made up of multiple computing devices 1100, 1150 communicating with each other.

Computing device 1150 includes a processor 1152, memory 1164, and an input/output device such as a display 1154, a communication interface 1166, and a transceiver 1168, among other components. The device 1150 can also be provided with a storage device, such as a micro-drive or other device, to provide additional storage. Each of the components 1150, 1152, 1154, 1164, 1166, and 1168, are interconnected using various buses, and several of the components can be mounted on a common motherboard or in other manners as appropriate.

The processor 1152 can execute instructions within the computing device 1150, including instructions stored in the memory 1164. The processor can be implemented as a chipset of chips that include separate and multiple analog and digital processors. Additionally, the processor can be implemented using any of a number of architectures. For example, the processor 1152 can be a CISC (Complex Instruction Set Computers) processor, a RISC (Reduced Instruction Set Computer) processor, or a MISC (Minimal Instruction Set Computer) processor. The processor can provide, for example, for coordination of the other components of the device 1150, such as control of user interfaces, applications run by device 1150, and wireless communication by device 1150.

Processor 1152 can communicate with a user through control interface 1158 and display interface 1156 coupled to a display 1154. The display 1154 can be, for example, a TFT (Thin-Film-Transistor Liquid Crystal Display) display or an OLED (Organic Light Emitting Diode) display, or other appropriate display technology. The display interface 1156 can comprise appropriate circuitry for driving the display 1154 to present graphical and other information to a user. The control interface 1158 can receive commands from a user and convert them for submission to the processor 1152. In addition, an external interface 1162 can be provide in communication with processor 1152, so as to enable near area communication of device 1150 with other devices. External interface 1162 can provide, for example, for wired communication in some implementations, or for wireless communication in other implementations, and multiple interfaces can also be used.

The memory 1164 stores information within the computing device 1150. The memory 1164 can be implemented as one or more of a computer-readable medium or media, a volatile memory unit or units, or a non-volatile memory unit or units. Expansion memory 1174 can also be provided and connected to device 1150 through expansion interface 1172, which can include, for example, a SIMM (Single In Line Memory Module) card interface. Such expansion memory 1174 can provide extra storage space for device 1150, or can also store applications or other information for device 1150. Specifically, expansion memory 1174 can include instructions to carry out or supplement the processes described above, and can include secure information also. Thus, for example, expansion memory 1174 can be provide as a security module for device 1150, and can be programmed with instructions that permit secure use of device 1150. In addition, secure applications can be provided via the SIMM cards, along with additional information, such as placing identifying information on the SIMM card in a non-hackable manner.

The memory can include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1164, expansion memory 1174, or memory on processor 1152 that can be received, for example, over transceiver 1168 or external interface 1162.

Device 1150 can communicate wirelessly through communication interface 1166, which can include digital signal processing circuitry where necessary. Communication interface 1166 can provide for communications under various modes or protocols, such as GSM voice calls, SMS, EMS, or MMS messaging, CDMA, TDMA, PDC, WCDMA, CDMA2000, or GPRS, among others. Such communication can occur, for example, through radio-frequency transceiver 1168. In addition, short-range communication can occur, such as using Bluetooth, Wi-Fi, or other such transceiver (not shown). In addition, GPS (Global Positioning System) receiver module 1170 can provide additional navigation- and location-related wireless data to device 1150, which can be used as appropriate by applications running on device 1150.

Device 1150 can also communicate audibly using audio codec 1160, which can receive spoken information from a user and convert it to usable digital information. Audio codec 1160 can likewise generate audible sound for a user, such as through a speaker, e.g., in a handset of device 1150. Such sound can include sound from voice telephone calls, can include recorded sound, e.g., voice messages, music files, etc., and can also include sound generated by applications operating on device 1150.

The computing device 1150 can be implemented in a number of different forms, as shown in the figure. For example, it can be implemented as a cellular telephone 1180. It can also be implemented as part of a smartphone 1182, personal digital assistant, or other similar mobile device.

Various implementations of the systems and methods described here can be realized in digital electronic circuitry, integrated circuitry, specially designed ASICs (application specific integrated circuits), computer hardware, firmware, software, and/or combinations of such implementations. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device, e.g., magnetic discs, optical disks, memory, Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device, e.g., a CRT (cathode ray tube) or LCD (liquid crystal display) monitor for displaying information to the user and a keyboard and a pointing device, e.g., a mouse or a trackball by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The systems and techniques described here can be implemented in a computing system that includes a back-end component, e.g., as a data server, or that includes a middleware component, e.g., an application server, or that includes a front end component, e.g., a client computer having a graphical user interface or a Web browser through which a user can interact with an implementation of the systems and techniques described here, or any combination of such back end, middleware, or front end components. The components of the system can be interconnected by any form or medium of digital data communication, e.g., a communication network. Examples of communication networks include a local area network (“LAN”), a wide area network (“WAN”), and the Internet.

The computing system can include clients and servers. A client and server are generally remote from each other and typically interact through a communication network. The relationship between client and server arises by virtue of computer programs running on the respective computers and having a client-server relationship with each other.

In the foregoing description, aspects, and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

Various components may be described as performing a task or tasks, for convenience in the description. Such descriptions should be interpreted as including the phrase “configured to.” Reciting a component that is configured to perform one or more tasks is expressly intended not to invoke 35 USC § 112(f) interpretation for that component.

For one or more implementations, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of implementations to the precise form disclosed. Modifications and variations are possible in light of the above teachings or may be acquired from practice of various implementations.

Although the implementations above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

We claim:

1. A method, comprising:
receiving, by a data processing system associated with a web platform, one or more first data structures representing one or more enrollment criteria from a school;
generating, by the data processing system and based on the one or more first data structures, an executable logic that identifies whether the one or more enrollment criteria are satisfied;
reading, by the data processing system and from a hardware storage device, second data structures representing school searchers registered on the web platform, wherein the second data structures are structured with fields, wherein the fields represent attributes of the school searchers and the fields store values of the attributes;
parsing, by a parser of the data processing system, the fields of the second data structures to identify the values of the attributes;
executing, by the data processing system, the executable logic against the identified values of the attributes;
based on the executing, identifying, by the data processing system, a subset of the second data structures representing a first set of school searchers meeting the one or more enrollment criteria of the school from the school searchers registered on the web platform;
identifying, by the data processing system and among the subset of the second data structures, one or more data structures in the subset representing a second set of school searchers, wherein each of the identified one or more data structures includes a first field representing a qualified inquiry of the school and a second field storing a value indicating the qualified inquiry; and
causing rendering, by the data processing system, on a display device, of a graphical user interface with one or more visual indicators of a conditional admission offer provided to the second set of school searchers, wherein the second set of school searchers are conditionally admitted school searchers.

2. The method of claim 1, further comprising sending a conditional scholarship offer to one or more qualified inquiries from the second set of school searchers.

3. The method of claim 2, further comprising sending information related to the conditional admission offer and the conditional scholarship offer to the school.

4. The method of claim 3, further comprising incorporating the information related to the conditional admission offer and the conditional scholarship offer into a customer relationship management (CRM) system of the school.

5. The method of claim 2, further comprising sending information related to the conditional admission offer and the conditional scholarship offer to the school through a secure file transfer protocol (SFTP).

6. The method of claim 5, further comprising:
encrypting the information related to the conditional admission offer and the conditional scholarship offer into encrypted data; and
sending the encrypted data to an SFTP server of the school.

7. The method of claim 1, further comprising sending one or more notifications reminding the one or more conditionally admitted school searchers of one or more actions to be taken associated with enrollment in the school.

8. The method of claim 1, further comprising tracking activities of the school searchers performed on the web platform, using a tracking pixel.

9. The method of claim 1, identifying the one or more data structures in the subset representing the second set of school searchers further comprises:
identifying the second set of school searchers that added the school to a school list or favorites on the web platform.

10. The method of claim 1, further comprising: receiving a school report including enrollment data of the school;
identifying school searchers enrolled in the school based on the school report; and
excluding the school searchers enrolled in the school from receiving a new conditional admission offer from other schools.

11. A system comprising:
at least one processor associated with a web platform; and
a memory storing instructions thereon that, when executed by the at least one processor, cause the at least one processor to perform operations, comprising:
receiving one or more first data structures representing one or more enrollment criteria from a school;
generating, based on the one or more first data structures, an executable logic that identifies whether the one or more enrollment criteria are satisfied;
reading, from a hardware storage device, second data structures representing school searchers registered on the web platform, wherein the second data structures are structured with fields, wherein the fields represent attributes of the school searchers and the fields store values of the attributes;
parsing the fields of the second data structures to identify the values of the attributes;
executing the executable logic against the identified values of the attributes;
based on the executing, identifying, from school searchers registered on the web platform, a subset of the second data structures representing a set of school searchers meeting the one or more enrollment criteria of the school;
causing rendering, on a display device, of a graphical user interface with one or more visual indicators of a conditional admission offer provided to the set of school searchers ; and
outputting one or more visual indicators of conditionally admitting one or more school searchers, among the set of school searchers, to the school based on an interest expressed from the one or more school searchers.

12. The system of claim 11, the operations further comprising sending a conditional scholarship offer to a subset of school searchers from the set of school searchers.

13. The system of claim 12, the operations further comprising sending information related to the conditional admission offer and the conditional scholarship offer to the school through a secure file transfer protocol (SFTP).

14. The system of claim 13, the operations further comprising incorporating the information related to the conditional admission offer and the conditional scholarship offer into a customer relationship management (CRM) system of the school.

15. The system of claim 13, the operations further comprising:
encrypting the information related to the conditional admission offer and the conditional scholarship offer into encrypted data; and
sending the encrypted data to an SFTP server of the school.

16. The system of claim 11, the operations further comprising sending one or more notifications reminding one or more conditionally admitted school searchers of one or more actions to be taken associated with enrollment in the school.

17. The system of claim 11, the operations further comprising tracking activities of the school searchers performed on the web platform, using a tracking pixel.

18. The system of claim 11, the operations further comprising outputting one or more visual indicators of canceling the conditional admission offer of one or more school searchers based on no interest expressed from the one or more school searchers among the set of school searchers.

19. A non-transitory, computer-readable storage medium having instructions stored thereon, that when executed by at least one processor associated with a web platform, cause the at least one processor to perform operations, comprising:
receiving one or more first data structures representing one or more enrollment criteria from a school;
generating, based on the one or more first data structures, an executable logic that identifies whether the one or more enrollment criteria are satisfied;
reading, from a hardware storage device, second data structures representing school searchers registered on the web platform, wherein the second data structures are structured with fields, wherein the fields represent attributes of the school searchers and the fields store values of the attributes;
parsing the fields of the second data structures to identify the values of the attributes;
executing the executable logic against the identified values of the attributes;
based on the executing, identifying a subset of the second data structures representing a first set of school searchers meeting the one or more enrollment criteria of the school from the school searchers registered on the web platform;
identifying, among the subset of the second data structures, one or more data structures in the subset representing a second set of school searchers, wherein each of the identified one or more data structures includes a first field representing a qualified inquiry of the school and a second field storing a value indicating the qualified inquiry; and
causing rendering on a display device, of a graphical user interface with one or more visual indicators of a conditional admission offer provided to the second set of school searchers, wherein the second set of school searchers are conditionally admitted school searchers.

20. The computer-readable storage medium of claim 19, the operations further comprising:
receiving a school report including enrollment data of the school;
identifying school searchers enrolled in the school based on the school report; and
excluding the school searchers enrolled in the school from receiving a new conditional admission offer from other schools.
